(19) United States
(12) Patent Application Publication
(10) Pub. No.: US 2016/0007335 A1
(43) Pub. Date: Jan. 7, 2016

(54) SLOT-BASED D2D COMMUNICATION METHOD AND APPARATUS

(71) Applicant: LG ELECTRONICS INC., Yeongdeungpo-gu Seoul (KR)

(72) Inventors: Jinyoung CHUN, Seoul (KR); Hangyu CHO, Seoul (KR); Suhwook KIM, Seoul (KR)

(73) Assignee: LG ELECTRONICS INC., Seoul (KR)

(21) Appl. No.: 14/767,873

(22) PCT Filed: Mar. 5, 2014
(86) PCT No.: PCT/KR2014/001817

§ 371 Date: Aug. 13, 2015

Related U.S. Application Data
(60) Provisional application No. 61/772,543, filed on Mar. 5, 2013.
(60) Provisional application No. 61/819,665, filed on May 6, 2013.
(60) Provisional application No. 61/843,432, filed on Jul. 7, 2013.

(51) Int. Cl. H04W 72/04; H04W 56/00; H04W 72/02; H04W 8/00

(52) U.S. Cl. CPC H04W 72/048; H04W 8/005; H04W 72/0446; H04W 56/001; H04W 72/02

(57) ABSTRACT

The D2D communication method may comprise the step of: transmitting, by a search device, a search request message through each of a plurality of channels in a search area, the search area corresponding to time resource allocated to integer multiple slots; receiving, by the search device, a search response message as a response to the search request message from a device found through at least one channel from among the plurality of channels in the search area, the search response message containing slot timing information and information on a first channel hopping pattern; synchronizing with the found device based on the slot timing information in a peering area by the search device; and performing communication with the found device, by the search device, on the basis of the information on the first channel hopping pattern in a communication area.

### BACKGROUND OF THE INVENTION

1. Field of the Invention

The present invention relates to wireless communication, and more particularly, to device-to-device (D2D) communication.

2. Related Art

As a wireless mobile terminal such as a smart phone and a tablet PC with high portability and excellent performance has been introduced, device-to-device (D2D) communication is getting the spotlight. D2D communication represents direct communication between terminals without passing through a base station or an access point (AP). The D2D communication may improve service quality for a user while reducing a load applied to a core network.

Peer aware communications (PAC) is a full distributed D2D communication technology making progress of standardization in a TG8 which is a new task group of IEEE 802.15. The PAC may generally support a main function of a D2D communication technology based on a user. The PAC may support fully distributed D2D communication without infrastructure, information search function with respect to a peer terminal without association, multi group communication, a relative location recognition function, multi-hop function, and a security function.

Since the PAC is standardization to satisfy demands of users with respect to increased D2D communication, if an existing wireless communication protocol is traditionally technology driven, the PAC is an application driven wireless communication protocol. A social network service (SNS), advertisements, and the like are regarded as a main application field of the PAC by reflecting a use pattern of current wireless mobile terminal users. Unlike the existing SNS, an SNS based on situation recognition or a location of the user may be provided using the PAC. Further, unlike an existing scheme depending on an infrastructure, in the advertisement, an advertising pattern for directly connecting the user with a peripheral advertiser may provide various free advertisements to buyers and convenience to consumers. In addition, group communication, communication between home appliances, and coverage extension through a relay are main application ranges of the PAC.

### SUMMARY OF THE INVENTION

The present invention provides a D2D communication method.

The present invention further provides an apparatus for performing the D2D communication method.

In an aspect, a device-to-device (D2D) communication method comprises transmitting, by a discovering device, a discovering request message via each of a plurality of channels in a discovering region, the discovering region corresponding to time resources allocated to integer multiple slot; receiving, by the discovering device, a discovering response message as a response to the discovering request message from a discovered device through at least one channel among the plurality of channels in the discovering region, the discovering response message containing slot timing information and information on a first channel hopping pattern; synchronizing with the discovered device based on the slot timing information in a peering region by the discovering device; and performing communication with the discovered device, by the discovering device based on the information on the first channel hopping pattern in a communication region, wherein the slot corresponds to one of a plurality of time resources having a same size included in a transmission period of a synchronization signal of the discovering device, wherein the slot timing information includes information on offset of a time when the discovering response message is transmitted based on a start point of a specific slot and wherein the information on the first channel hopping pattern includes information on a first operation channel of the discovered device hopped during a channel hopping period in the communication region.

In another aspect, A discovering device for performing a device-to-device (D2D) communication, the discovering device comprises a radio frequency (RF) unit configured to transmit and receive a radio signal and a processor operatively connected to the RF unit and configured to: transmit a discovering request message via each of a plurality of channels in a discovering region, the discovering region corresponding to time resources allocated to integer multiple slot, receive a discovering response message as a response to the discovering request message from a discovered device through at least one channel among the plurality of channels in the discovering region, the discovering response message containing slot timing information and information on a first channel hopping pattern, synchronize with the discovered device based on the slot timing information in a peering region by the discovering device and perform communication with the discovered device, by the discovering device based on the information on the first channel hopping pattern in a communication region, wherein the slot corresponds to one of a plurality of time resources having a same size included in a transmission period of a synchronization signal of the discovering device, wherein the slot timing information includes information on offset of a time when the discovering response message is transmitted based on a start point of a specific slot, and wherein the information on the first channel hopping pattern includes information on a first operation channel of the discovered device hopped during a channel hopping period in the communication region.

A search procedure between terminals in the D2D communication may be performed to have small delay latency. Further, when one terminal generates a communication link with a plurality of other terminals to perform D2D communication, one terminal may communicate with the plurality of other terminals based on the same synchronization.

### BRIEF DESCRIPTION OF THE DRAWINGS

FIG. 1 is a conceptual diagram illustrating a method of synchronizing a time between neighboring UEs in D2D communication.

FIG. 2 is a conceptual diagram illustrating a method of synchronizing a time between neighboring UEs in a D2D communication system according to an embodiment of the present invention.

FIG. 3 is a conceptual diagram illustrating a search region according to an embodiment of the present invention.

FIG. 4 is a conceptual diagram illustrating a D2D communication method of a terminal according to an embodiment of the present invention.

FIG. 5 is a conceptual diagram illustrating a discovering region according to an embodiment of the present invention.

FIG. 6 is a conceptual diagram illustrating a discovering region according to an embodiment of the present invention.

FIG. 7 is a conceptual diagram illustrating a discovery request message and a discovery response message according to an embodiment of the present invention.

FIG. 8 is a conceptual diagram illustrating a discovering region according to an embodiment of the present invention.

FIG. 9 is a conceptual diagram illustrating a discovery procedure according to an embodiment of the present invention.

FIG. 10 is a conceptual diagram illustrating a PAC based D2D communication method according to an embodiment of the present invention.

FIG. 11 is a conceptual diagram illustrating a peering region according to an embodiment of the present invention.

FIG. 12 is a conceptual diagram illustrating a communication region according to an embodiment of the present invention.

FIG. 13 is a conceptual diagram illustrating a D2D communication method according to an embodiment of the present invention.

FIG. 14 is a block diagram illustrating a wireless apparatus according to an embodiment of the present invention.

### DESCRIPTION OF EXEMPLARY EMBODIMENTS

The UE may refer to other terms such as a mobile station (MS), a mobile terminal (MT), a user terminal (UT), a subscriber station (SS), a wireless device, a personal digital assistant (PDA), a wireless modem, a handheld device peer aware communications (PAC) device, and a PAC device (PD).

In recent years, D2D communication which allows UE to communicate with a peripheral specific person or a plurality of specific UEs instead of a server and shares multi-media is getting the spotlight. A plurality of smart phone applications supports the above service.

In most existing communication environments, the user accesses a server to download or upload desired contents. Such a communication environment may refer to an infrastructure communication environment. In the infrastructure communication environment, the user mainly uses a base station of cellular communication or an access point (AP) of a wireless LAN in order to access the server.

Up to now, the D2D communication is generally performed in an application layer. That is, an operation of the UE in a physical layer (PHY) being an upper layer of the application layer and a medium access control (MAC) layer are the same as an operation of UE in a previous infrastructure communication environment.

To support the D2D communication in the physical layer and the MAC layer may present great advantages. The data should be transmitted through the server according to the related art. However, data are directly exchanged between UEs, a wireless resource may be efficiently used. Further, since the data are directly exchanged between UEs, transmission delay is significantly low. Since the data are transmitted to a relatively short distance, transmission power may be saved. Further, since connection with the server is not required, there is no billing burden of the user side so that a large amount of data may be transmitted.

The D2D communication environment is very different from the infrastructure communication environment. Since there is no base station or AP in the D2D communication environment, an access method different from that of the related art should be used with respect to wireless resource distribution. Interference in the D2D communication environment is different from that of the related art. In addition, in the D2D communication environment, synchronization between UEs may be different from synchronization of an infrastructure communication environment. The PHY and MAC layers of the D2D communication should be designed by taking into consideration the difference between the D2D communication environment and the infrastructure communication environment.

The communication environment in which the D2D communication is performed may have following characteristics.

It may be assumed that mobility of the UE in the D2D communication is greater than that of the infrastructure communication environment. It is assumed that the base station or the AP is fixed in an existing infrastructure communication environment. However, both of a transmitter or a receiver frequently has mobility in the D2D communication. It may be assumed that the mobility of the UE is relatively great.

The D2D communication may frequently include multi-session. According to the related art, the UE forms a session with the base station/AP and uploads and downloads contents. However, one UE may maintain a plurality of sessions with a plurality of other UEs. For example, one UE may exchange chatting relation data with specific UEs and may exchange a music file or a moving image file with another UE.

A plurality of UEs may perform communication based on different synchronization at the D2D communication. The related art synchronizes a network based on the base station and/or the AP. However, synchronization using the base station and/or the AP is impossible in the D2D communication.

General D2D communication may be performed based on a discovery procedure, a coupling procedure, and a communication procedure. The discovery procedure is a procedure to find a communicable neighboring UE.

The discovering procedure may transmit a discovery request message or may receive a discovery response message responding a discovery request message of another terminal

The association procedure is a procedure where the UE is coupled with another UE. The coupling procedure may transmit and receive detailed information or security information necessary for synchronization procedure communication.

The communication procedure is a procedure for transmitting and receiving real data between UEs. The communication procedure may transmit and receive the data between UEs after the coupling is performed through the coupling procedure.

It is assumed in the D2D communication that the UE transmits and receives access and data at a channel based on carrier sense multiple accesses with contention avoidance (CSMA/CA). That is, the UE may perform the discovery procedure, the association procedure, and the communication procedure based on contention.

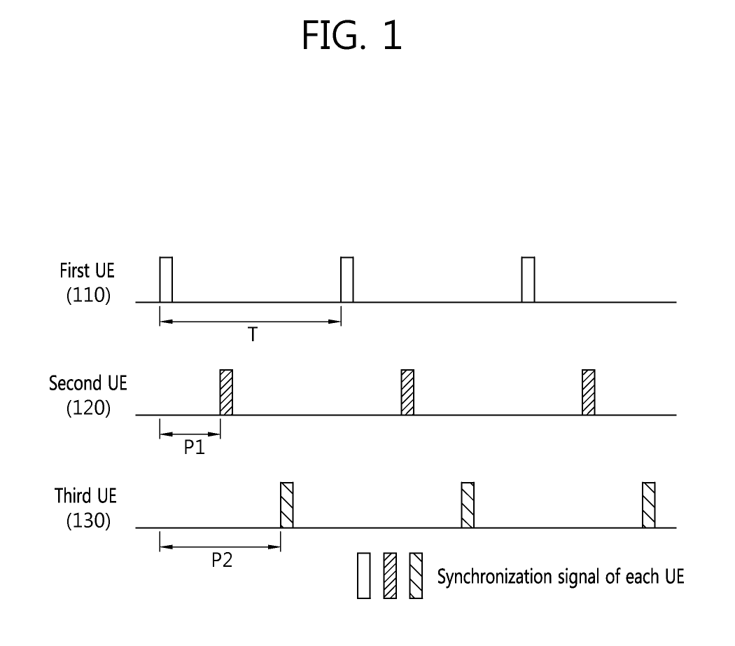

FIG. 1 is a conceptual diagram illustrating a method of synchronizing a time between neighboring UEs in D2D communication.

FIG. 1 starts a method of synchronizing a time with a neighboring UE by UE based on a continuous time synchronizing method. A procedure of synchronizing a time with the neighboring UE by the UE may be performed through a procedure after the discovery procedure.

Referring FIG. 1, each UE may periodically transmit a time synchronization signal. The time synchronization signal may include a signal to be transmitted in order to synchronize the UEs with each other. For example, the first UE 110 may acquire time synchronization with respect to the second UE 120 by receiving a time synchronization signal from the second UE 120 being a neighboring UE. When the continuous time synchronization method is used, since an exact time delay value according to a distance between the first UE 110 and the second UE 120 cannot be reflected, time synchronization of the first UE 110 with respect to the second UE 120 determined based on the time synchronization signal may not be exact.

Further, when the UE acquires time synchronization information of another UE on a continuous time using a continuous time synchronization scheme, as the number of other UEs communicating with the UE is increased, there may be overhead to know continuous time synchronization information with respect to a plurality of UEs.

Referring to FIG. 1, there is a difference of p1 between a time to transmit a time synchronization signal by the first UE 110 and a time to transmit a time synchronization signal by the second UE 120. Further, it may be assumed that there is a difference of p2 between the time to transmit the time synchronization signal by the first UE 110 and a time to transmit a time synchronization signal by the third UE 130.

The first UE 110 may receive the time synchronization signal from the second UE 120 and the third UE 130, and may acquire time synchronization with the second UE 120 and the third UE 130. Since time synchronization between the second UE 120 and the third UE 130 acquired by the first UE 110 is a reflected value of the time delay value according to a distance, the time synchronization may have an error of p1 and p2 which is a real value. The p1 and the p2 may be a value on a continuous time domain.

Accordingly, the present invention discloses a method of easily acquiring synchronization of another UE by the UE in order to perform D2D communication by configuring synchronization of communication UE as a discrete value.

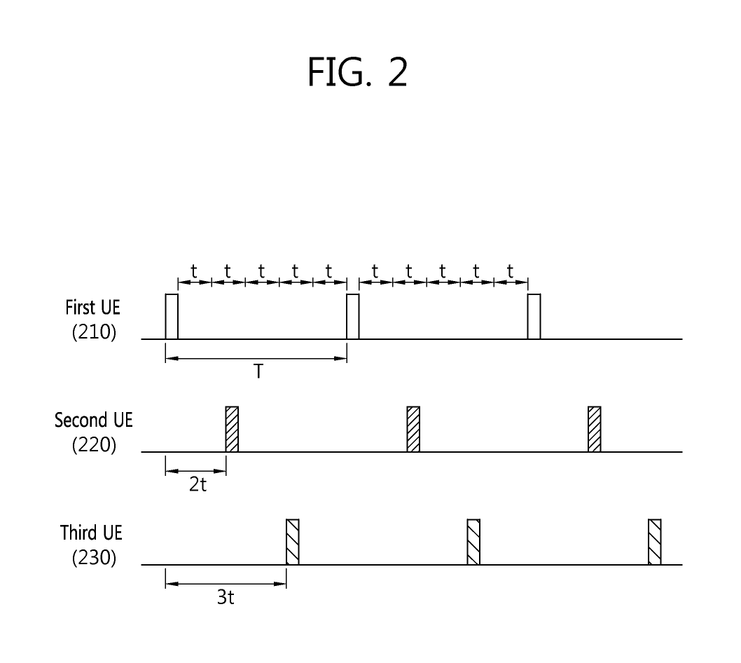

FIG. 2 is a conceptual diagram illustrating a method of synchronizing a time between neighboring UEs in a D2D communication system according to an embodiment of the present invention.

FIG. 2 illustrates a method of acquiring time synchronization of another UE by a specific UE through a discrete time synchronization method. Each UE may transmit the time synchronization signal with a plurality of discrete values on a time domain. By using the above method, the UE may determine time synchronization of another UE on the time domain as one of a plurality of discrete values on the time domain which is not a continuous value.

The time synchronization method of D2D communication may refer to a semi-sync method.

As shown in FIG. 2, the time synchronization between the second UE 220 and the third UE 230 based on the first UE 210 may be one of discrete values corresponding to a integer multiple of t. Hereinafter, in the embodiment of the present invention, a time unit t may be defined as one slot or one synchronization slot. Hereinafter, in the embodiment of the present invention, the term “slot” is used. The slot may correspond to one time resource of a plurality of time resources having the same size included in a transmission period of a synchronization signal from the discovering device.

Hereinafter, the embodiment of the present invention discloses a method of efficiently performing a discovery procedure in D2D communication using the semi-synchronization method. When a resource of a time domain is operated based on the semi-synchronization method in the D2D communication, the discovery procedure of the UE may be performed based on the slot on the time domain. The discovery procedure of the UE may be performed for discovery between UEs before performing synchronization between the UEs.

The discovering region is a specific time region and may be a time interval to perform a discovery procedure for discovering another UE by the UE. For example, the discovering region may be previously determined like a slot after a slot to which the synchronization signal is transmitted. Alternatively, the discovering region may be determined based on a predetermined parameter. For example, the discovering region of the UE may be determined based on an operation channel of the UE.

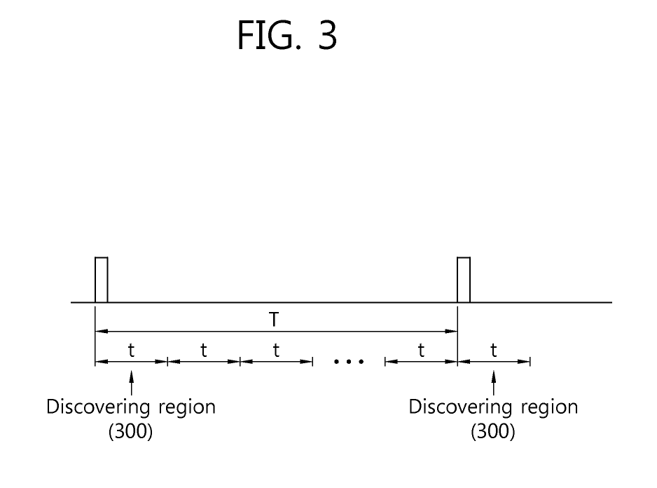

FIG. 3 is a conceptual diagram illustrating a search region according to an embodiment of the present invention.

Referring to FIG. 3, an interval between synchronization signals transmitted from the UE on the time domain refers to T, and the interval T may be divided into a time resource having n intervals t. In this case, n is an integer equal to or greater than 1, and T and t may be a value on the time domain. That is, n slots having a size t at an interval T may be generated.

The embodiment of the present invention may designate at least zero slots among n intervals t included in a T time interval as the discovering region 300. A case of 0 is a case where the discovering region is not included in the slot.

The slot based discovery method may be usable in a discovery procedure of D2D communication based on a plurality of channels as in a case where a channel performing communication is different from a channel performing discovery or the UE communicates with a plurality of UEs based on multi-session.

For example, a discovery procedure based on the discovering region 300 may be efficient so that one UE communicates with a plurality of UEs as in a case of performing a discovery procedure with respect to the second channel in order to communicate with the third UE located at the second channel while the first UE communicates with the second UE through the first channel.

In the existing case, an implementation issue is a method of performing a discovery procedure with respect to another channel by the UE operating in a specific channel. That is, a discovery procedure with respect to another channel may be performed using various methods according to implementation of the present invention. When performing different discovery procedures according to implementation of a plurality of UEs, a discovery performance of the UE may be reduced.

According to the embodiment of the present invention, when the terminal performs a discovery procedure with respect to another channel, the discovery performance may be prevented from being reduced due to various discovery procedures between existing UEs by designating a separate discovery region 300.

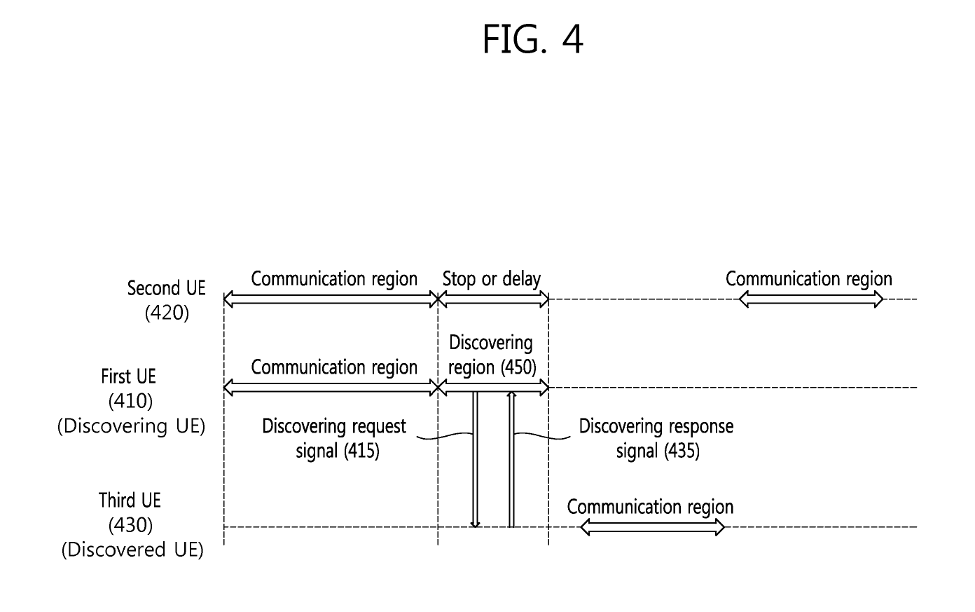

FIG. 4 is a conceptual diagram illustrating a D2D communication method of a terminal according to an embodiment of the present invention.

FIG. 4 discloses a method of performing a discovery procedure with respect to the third UE 430 operating in the second channel while the first UE 410 communicates with the second UE through the first channel.

Hereinafter, in the embodiment of the present invention, UE such as the first UE 410 for transmitting a discovery request signal 415 to perform the discovery may be expressed as a term such as a discovering UE or a discovering PD, and a discovering device. UE such as the third UE 430 being a discovery object for transmitting a discovery response signal 435 to perform the discovery may be expressed as a term such as a discovered UE or a discovered PD or a discovering object UE, and a discovered device.

Referring to FIG. 4, the second UE 420 communicating with the first UE 410 through the first channel may stop (or delay) a procedure of communicating with the first UE 410 at a discovering region. For example, the second UE 420 may acquire information on the discovering region 450 of the first UE 410 based on data transmitted from the first UE 410. The second UE 420 may reduce communication loss (a case where there is no receiver but transmission is performed or a case where there is no transmitter but reception is waited) by stopping (or delaying) communication with the first UE 410 at the discovering region 450 of the first UE 410.

The first UE 410 being the discovering UE may perform a discovery procedure at the discovering region 450. The discovery procedure performed in the discovering region 450 may be defined as a procedure of transmitting a signal (hereinafter referred to discovery request signal 415) for discovery and a procedure of receiving a response signal (hereinafter referred to discovery response signal 435) with respect to the discovery request signal 415. The discovery procedure with respect to a plurality of channels may be performed in various methods. Hereinafter, the discovery procedure with respect to a plurality of channels according to an embodiment of the present invention will be disclosed.

The first UE 410 being the discovering UE may transmit the discovery request signal 415 to the third UE 430 being a discovery object UE through the second channel at a discovering region. The third UE 430 may transmit the discovery response signal 435 as a response to the discovery request signal 415 of the first UE 410.

FIG. 4 illustrates a directly discovered case because a communication procedure is continuously performed at the second channel when the third UE 430 transmits a discovery request signal with respect to the second channel of the first UE 410.

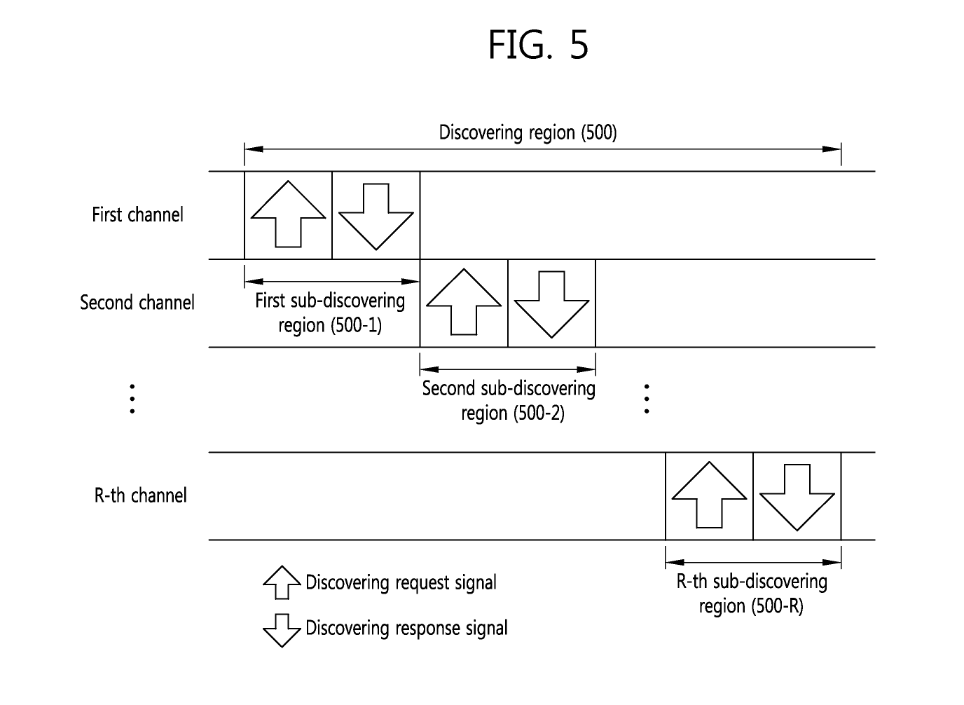

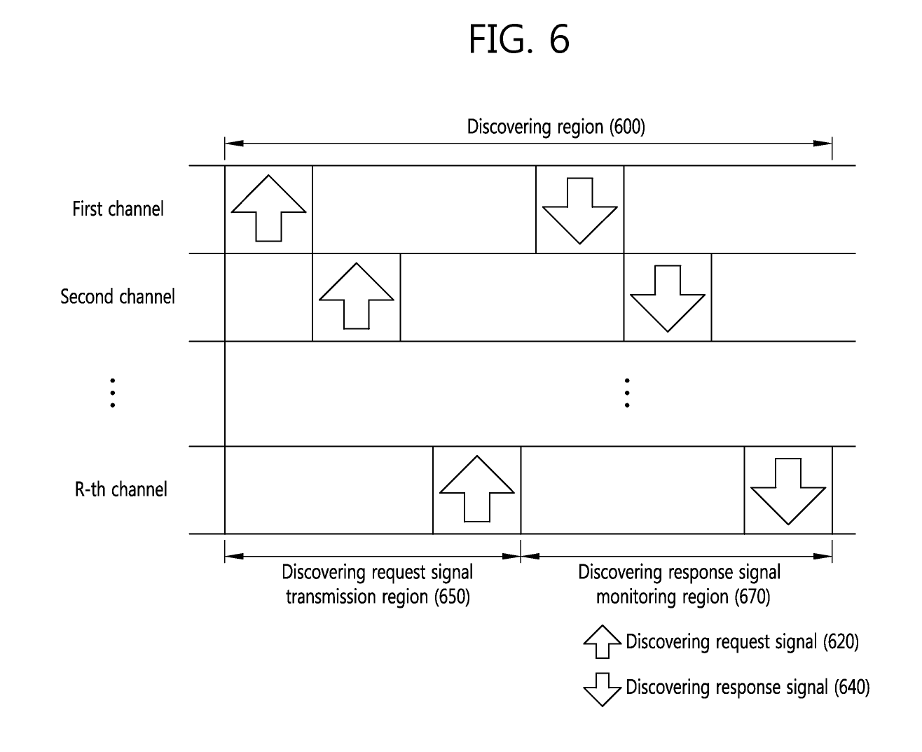

If the third UE 430 hops an operation channel to another channel, the UE may discover the third UE 430 through an additional discovery procedure with respect to another channel. Hereinafter, FIG. 5 and FIG. 6 illustrate a method of performing a discovery procedure with respect to a plurality of channels by UE.

Further, if the discovering region of the third UE 430 overlaps with the discovering region of the first UE 410, the discovery procedure of the first UE 410 may fail. A discovering region definition method for reducing the above case will be described in detail.

FIG. 5 is a conceptual diagram illustrating a discovering region according to an embodiment of the present invention.

The discovering region 500 may be divided into a region to transmit the discovery request signal 520 and a region to monitor the discovery response signal 540 transmitted from a discovery object UE.

When the D2D communication is performed based on a plurality of channels, the UE may discover a plurality of channel from the discovering region 500.

For example, when there is a plurality of channels (R is an integer when R>0) supporting the D2D communication, the discovering region 500 is divided into a plurality of parts so that a plurality of channels may be discovered in the discovering region 500.

FIG. 5 illustrates a case of directly receiving a discovery response signal 540 being a response with respect to the discovery request signal 520 at the discovering region 500.

Referring to FIG. 5, a sub-discovering region in the discovering region 500 may be defined. In the sub-discovering region, the discovering UE may transmit a discovery request signal 520 with respect to a specific channel, and may monitor a discovery response signal 540 transmitted from the discovery object terminal operating at the specific channel. The discovery procedure with respect to a plurality of discovery channels may be performed through all sub-discovering regions in the discovering region 500. That is, the discovering region may be divided into a plurality of sub-discovering regions based on the number of the plurality of channels, and the plurality of sub-discovering regions may correspond to the plurality of channels, respectively. Each of the plurality of sub-discovering regions may include a first region for transmitting a discovery request message through the plurality of channels and a second region for monitoring the discovery response message transmitted through the plurality of channels.

For example, the discovering UE may sequentially perform the discovery procedure with respect to all channels upon performing a discovery procedure through the sub-discovering region. That is, all channels supported from the D2D communication may be the discovery channel. For example, it may be assumed that the D2D communication may be performed through a first channel to an R channel. In this case, the discovering UE may transmit the first discovery request signal through a first channel at the first sub-discovering region 500-1, and may monitor the first discovery response signal transmitted through the first channel. In the same manner, the discovering UE may transmit the second search request signal through the second channel at the second sub-discovering region 500-2 to monitor the second discovery response signal, and may transmit an R discovery request signal through the R channel at the R sub-discovering region 500-R to monitor an R discovery response signal. When the discovering UE receives the discovery response signal from the discovery object UE, the UE may again transmit ACK to another UE transmitting the discovery response signal. If another U receives the ACK, another UE may wait at a corresponding channel for communication with UE without moving to another operation channel.

As another example, when the discovering UE determines only the specific channel as the discovery channel, the sub-discovering region may be defined with respect to only the specific channel configured as the discovery channel. For example, an operation channel of a current UE may not be configured as the discovery channel.

Further, according to an embodiment of the present invention, a time allocated to each sub-discovering region and/or a time to monitor a discovery response signal transmitted from a discovery object UE at the sub-discovering region by the discovering UE may be differently configured.

Further, the time to transmit the discovery request signal at the sub-discovering region and the time to monitor the discovery response signal by the UE may be variously configured.

In addition, the UE may not transmit the discovery request signal at a specific sub-discovering region. The UE may discover another UE operating at a discovery channel by receiving only the discovery request signal transmitted from another discovering UE at each discovery channel.

FIG. 6 is a conceptual diagram illustrating a discovering region according to an embodiment of the present invention.

FIG. 6 illustrates a method of performing a discovery procedure by dividing the discovering region 600 into a discovery request signal transmission region 650 and a discovery response signal monitoring region 670.

Referring to FIG. 6, in the discovery request signal transmission region 650, the discovering UE may transmit the discovery request signal 620 to each discovery channel. In a discovery response signal monitoring region 670 after the discovery request signal transmission region 650, as a response with respect to the discovery request signal transmitted from the discovering UE, the discovery response signal 640 transmitted from the discovery object UE may be monitored. If the discovering UE receives the discovery response signal 640 from the discovery object UE, the discovering UE may transmit ACK to the discovery object UE transmitting the discovery response signal 640. If the discovery object UE receives the ACK, the discovery object UE does not move to another operation channel but may wait at a corresponding channel to communicate with the discovering UE.

The discovering UE may sequentially transmit the discovery request signal 620 with respect to all channels when transmitting the discovery request signal through the discovery request signal transmission region 650. That is, all channels supported from the D2D communication may be the discovery channel. For example, it may be assumed that the D2D communication is performed through the first channel to the R-th channel. In this case, the discovering UE may transmit the first discovery request signal through the first channel in the discovery request signal transmission region 650. The discovering UE may transmit the second discovery request signal and may transmit the R-th discovery request signal through the R-th channel. Moreover, the discovering UE may monitor a first discovery response signal transmitted from the discovery object UE through the first channel at the discovery response signal monitoring region 670. The discovering UE may monitor the second discovery response signal transmitted from the discovery object UE through the second channel. The discovering UE may monitor the R-th discovery response signal transmitted from the discovery object UE through the R-th channel.

As another example, when the discovering UE determines only the specific channel as the discovery channel, the discovering UE may transmit the discovery request signal with respect to only the specific channel at the discovery request signal transmission region 650, and may monitor the discovery response signal transmitted through the specific channel at the discovery response signal monitoring region 670. For example, the operation channel of the current UE may not be configured as the discovery channel by the UE.

In addition, a time to transmit the discovery request signal with respect to each discovery channel at the discovery request signal transmission region 650 and/or a time to monitor the discovery response signal transmitted through each discovery channel from the UE at the discovery response signal monitor region 670 may be differently configured.

Further, the discovering UE may discover another UE operating in the discovery channel by receiving only the discovery request signal 620 transmitted from another discovering UE at each discovery channel by defining only a discovery response signal monitoring region 670 and without defining the discovery request signal transmission region 650.

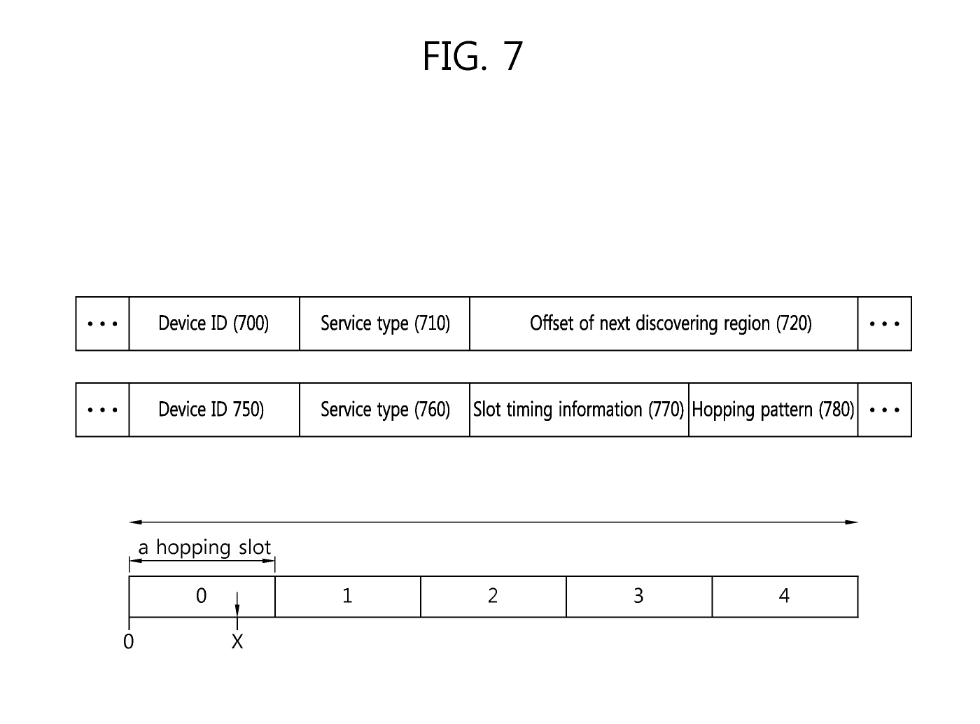

FIG. 7 is a conceptual diagram illustrating a discovery request message and a discovery response message according to an embodiment of the present invention.

A top end of FIG. 7 represents a discovery request message.

Referring to the top end of FIG. 7, the discovery request message may include a device identifier (ID) 700, a service type 710, and offset of a next discovering region 720.

The device ID 700 may include ID information of the discovering UE for transmitting the discovery request message. The device ID 700 may include ID information such as a MAC address of the discovering UE capable of identifying the UE.

The service type 710 may include information on a service category. For example, the service type 710 may classified into various service types such as real-time streaming, display, and voice over internet protocol (VoIP).

The offset 720 of the next discovering region may include information on a next discovering region of the discovering UE. If the discovery object UE receives the discovery request message but does not transmit a discovery response message due to contention, the discovery object UE may transmit the discovery response message to the discovering UE at a next discovering region of the discovery object UE based on information included in the offset 720 of the next discovering region.

Referring to a middle end of FIG. 7, the discovery response message may include a device ID 750, a service type 760, slot timing information 770, and information on a hopping pattern 780.

The device ID 750 may include ID information of the discovery object UE to transmit the discovery response message.

The service type 760 may include information on the service category. If the service type 760 is the same as information on a service type included in the discovery request message, the information on the service type included in the discovery response message may be omitted.

The slot timing information 770 may include information on an index of a slot to transmit a discovery response message and time offset information based on a start point of the slot.

A bottom end of FIG. 7 is a conceptual diagram illustrating information included in slot timing information 770. The slot timing information 770 may include information on an index of a slot to transmit the discovery response message and time offset information based on a start point of the slot.

The hopping pattern 780 may include information on a pattern to perform channel hopping in a communication region.

The discovery procedure is a procedure performed before synchronizing a time between the discovering UE and the discovery object UE. Accordingly, the UE may not exactly know a location of a slot of another UE. In this case, when the UE performs a discovery procedure through the discovering region, discovery latency may be generated. Accordingly, in the embodiment of the present invention, in order to reduce the discovery latency, a plurality of continuous slots (e.g., two slots) may be defined and used as the discovering region.

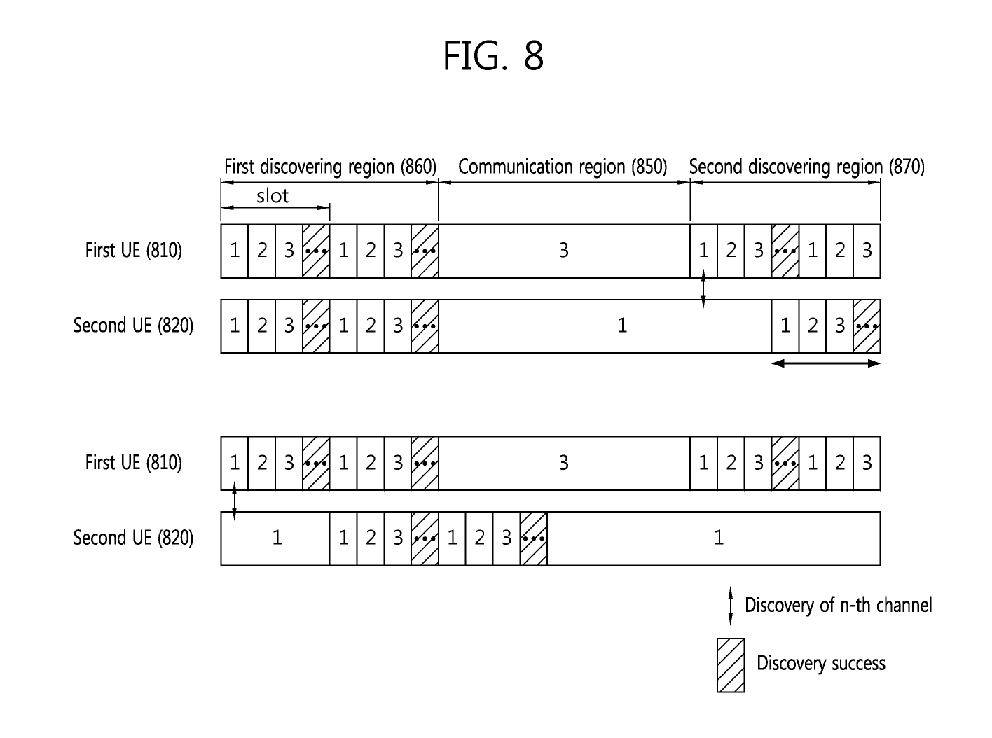

FIG. 8 is a conceptual diagram illustrating a discovering region according to an embodiment of the present invention.

FIG. 8 illustrates a case where the first UE 810 discovers the second UE 820. The discovering regions 860 and 870 include two slots 840, and a discovering region may be individually defined in each slot 840.

As shown in FIG. 5, each discovering region may include a plurality of sub-discovering regions. The UE may perform a discovery procedure with respect to another UE at each sub-discovering region.

The following description will be made while focusing on the first UE. A top end of FIG. 8 illustrates a case where a first discovering region 860 of the first UE 810 overlaps with a discovering region of the second UE 820 at an interval of one slot 840 or greater.

In detail, as shown in the top end of FIG. 8, when the first discovering region 860 of the first UE 810 fully overlaps with the discovering region of the second UE 820, the first UE 810 may discover the second UE 820. After the discovering region of the first UE 810 overlaps with the discovering region of the second UE 820 so that the discovery of the first UE 810 fails, the second UE 820 may communicate with in the first channel. When the second discovering region 870 of the first UE 810 overlaps with a communication region of the second UE 820 on a time domain, the first channel is discovered at the second discovering region 870 of the first UE 810 so that the second UE 820 operating in the first channel may be discovered. In detail, the second UE may be discovered at a region discovering the first channel among sub-discovering regions included in the second discovering region 870. In this case, the discovery latency may occur by a value obtained by adding one slot to a period to a next discovering region.

A bottom end of FIG. 8 illustrates a case where the first discovering region 860 of the first UE 810 overlaps with the discovering region of the second UE at a period less than one slot. In this case, the discovery latency may have a maximum value smaller than one slot.

In detail, as illustrated in the bottom end of FIG. 8, when the first discovering region 860 of the first UE 810 overlaps with the discovering region of the second UE at a period less than one slot, the UE may discover the second UE 820 operating at the first channel from the first discovering region 860. In this case, the discovery latency of the first UE 810 may be less than one slot.

According to the embodiment of the present invention, when the discovering region includes two slots, each slot may perform the same discovery procedure based on the same configuration as described above. FIG. 8 illustrates a method of discovering respective channels in a sub-discovering region. According to the embodiment of the present invention, as shown in FIG. 6, a method of performing a discovery procedure is equally applicable by dividing the discovering region into a discovery request signal transmission region and a discovery response signal monitoring region. That is, the discovering region defined by a discovery request signal transmission region and a discovery response signal monitoring region may be repeated.

A following table 1 lists reduction of discovery latency when the discovering region includes two slots as shown in FIG. 8 and there is a communication region after the discovering region.

A simulation result of the table 1 represents a case where a time resource of the UE is allocated as a discovering region and a communication region in which the first UE PD A starts transmits from the discovering region and the second UE randomly starts. Further, it is assumed that the total number of available channels is three.

In the table 1, F indicates that a communication region of the second UE is fixed and operated at a randomly selected channel. H indicates that a communication region of the second UE is randomly hopped in a slot unit.

The S means one slot. A D means that a discovering region is one slot (D=S). A DD means that the discovering region is duplicated and repeated (S=DD).

The communication region may be selected as one of 3S, 6S, and 9S.

TABLE 1

| | | Discovery | |
|---|---|---|---|
| Case | Abbreviation | latency (S) | Analysis |
| Case1 | F.CD | 24.5 | Similar to Wi-Fi direct(almost Wi-Fi |
| | | | direct case (S = about 10 ms)) |
| Case 2 | H.CD | 27.6 | Channel hopping is a solution to |
| | | | support concurrent mode. So it says |
| | | | that there is performance loss to |
| | | | support concurrent mode in Wi-Fi |
| | | | directions system |
| Case 3 | H.CDD | 24.7 | Discovery latency is about 3 slots less |
| | | | than case 2 due to duplicated |
| | | | discovering region |
| Case 4 | H.DC | 9.9 | If PD A wants to discover others, the |
| | | | PD has to start from the discovering |
| | | | region. So we propose PDs starts |
| | | | from the discovering region |
| Case 5 | H.DDC | 7.1 | Discovery latency is about 3 slots less |
| | | | than case 4 due to duplicated |
| | | | discovering region. So we propose |
| | | | discovering region has to be |
| | | | duplicated in the channel hopping |
| | | | system |

Table 1 represents the discovery latency according to various resource allocation of the discovering UE.

Referring to the table 1, it may be confirmed in a case of H.DDC, the discovery latency of the UE has the minimum value. That is, when the UE allocates a time resource to a duplicated discovering region and a communication region hopped in a slot unit, it may be confirmed that the UE has a minimum discovery latency value. That is, as in the embodiment of the present invention, when the discovering region is repeated in two slots, the discovery latency of the UE may be reduced.

According to another embodiment of the present invention, each slot included in the discovering region may be operated in various schemes for various discovery procedures. For example, some of a plurality of slots configured as the discovering region may be used to transmit a discovery request signal, and remaining slots may be used to receive a discovery response signal.

Alternatively, at a discovery period to transmit one discovery request signal among the discovering region and to receive a response thereof may exchange a message for a procedure after the discovery procedure instead of the discovery procedure at the same period of a next discovering region. For example, the message for a peering procedure and a communication procedure to be described later may be transmitted and/or received.

Further, when the UE turns-on power to firstly attempt the discovery procedure, the UE does not designate the discovering region as a separate region but may continuously change the channel for a rapid discovery procedure to transmit and receive the discovery request message/discovery response message. When the UE turns-on power to firstly attempt the discovery procedure, the UE may include a continuous discovering region until the UE discovers a specific UE.

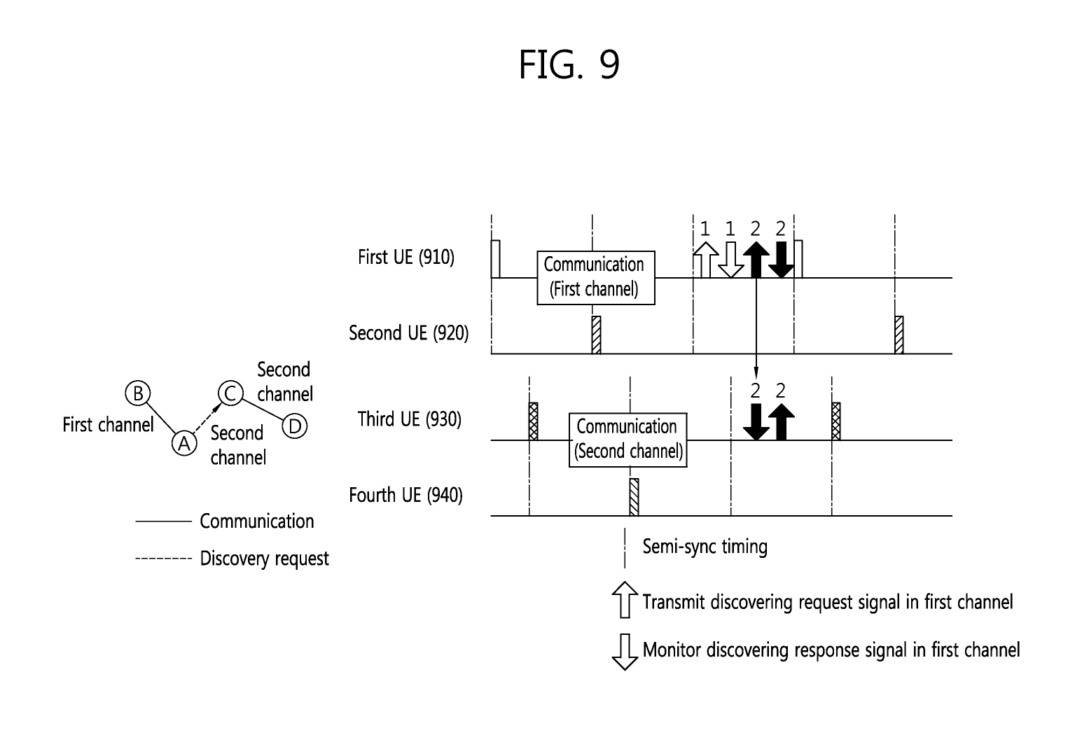

FIG. 9 is a conceptual diagram illustrating a discovery procedure according to an embodiment of the present invention.

It is assumed in FIG. 9 that the first UE 910 communicates with the second UE 920 through a first channel, and the third UE 930 communicates with the fourth UE 940.

When the first UE 910 discovers another UE from the discovering region as a discovering UE, the first UE 910 may perform a discovery procedure through the above various methods. For example, the discovering region may include a plurality of sub-discovering regions. The UE may transmit a discovery request message through the first channel at the first sub-discovering region, and may receive the discovery response message being a response with respect to the discovery request message from the discovery object terminal The UE may transmit the discovery request message through the second channel at the second sub-discovering region, and may receive the discovery response message being a response with respect to the discovery request signal from the discovery object UE through the second channel.

The first UE 910 may receive the discovery response message from the third UE 930 as a response to the discovery request message at the second channel. When the first UE 910 receives the discovery response message, the first UE 910 may transmit an ACK message to the third UE 930. If the third UE 930 receives the ACK message, the third UE 930 may not move to another channel from the second channel.

If the first UE 910 receives the discovery response message from the third UE 930, the first UE 910 may communicate with the third UE 930 by performing a procedure after the discovery procedure.

The second UE 920 may delay or stop communication with the first UE 910 at a discovering region of the first UE 910, and may restart communication with the first UE 910 after the discovering region.

That is, the first UE 910 may communicate with the second UE 920 and the third UE 930 after the discovering region.

When the first UE 910 communicate with the second UE 920 and the third UE 930 after the discovering region, the second UE 920 may be operated according to time synchronization achieved by the existing communication procedure. However, the third UE 930 does not synchronize a time with the first UE 910. Accordingly, it may be difficult for the first UE 910 to communicate with the second UE 920 and the third UE 930 while maintaining a plurality of sessions.

In order to solve the above problem, the embodiment of the present invention may define a communication procedure with a plurality of UEs by defining a peering period.

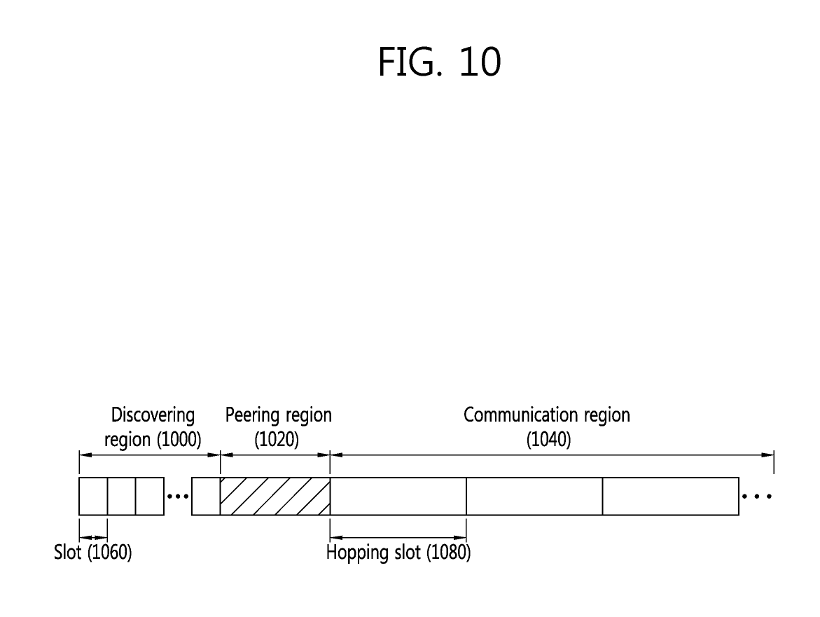

FIG. 10 is a conceptual diagram illustrating a PAC based D2D communication method according to an embodiment of the present invention.

Referring to FIG. 10, the PAC based D2D communication may be performed through the discovering region 1000, the peering region 1020, and the communication region 1040. The discovery procedure may be performed at the discovering region 1000, a peering procedure may be performed in the peering region 1020, and a communication procedure may be performed at the communication region 1040.

The discovering region 1000 may be a region required when the UE discovers another UE. The time resource of the discovering region 1000 may be classified in a unit of the slot 1060. In the discovering region 1000, the UE may perform a discovery procedure based on the above method as illustrated in FIG. 2 to FIG. 9.

The peering region 1020 may include a region in which the discovering UE synchronizes with the discovery object UE discovered through the discovery procedure and performs peering. Since a length of the period for the synchronization may be changed, the size of the peering region 1020 may be adaptively changed. In the peering region 1020, the UE may configure the same slot timing as that of the other UE, and may exchange peering information with the other UE.

The communication region 1040 may include a region to really communicate with another UE. The size of the communication region 1040 may be a unit of the hopping slot 1080. The hopping slot 1080 may be a unit of a slot performing hopping. The hopping slot 1080 may be the same unit as that of the slot 1020. The operation channel of the UE may be changed according to the hopping pattern. The UE may communicate with another UE based on the same slot timing and the hopping pattern achieved based on synchronization.

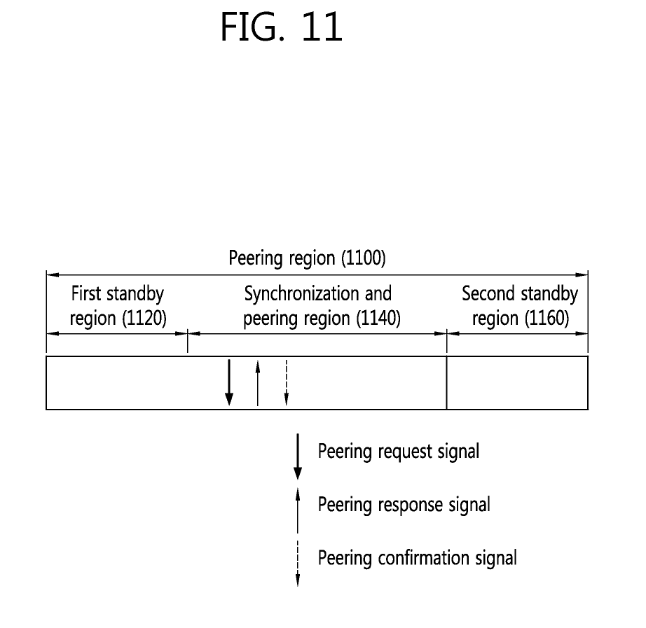

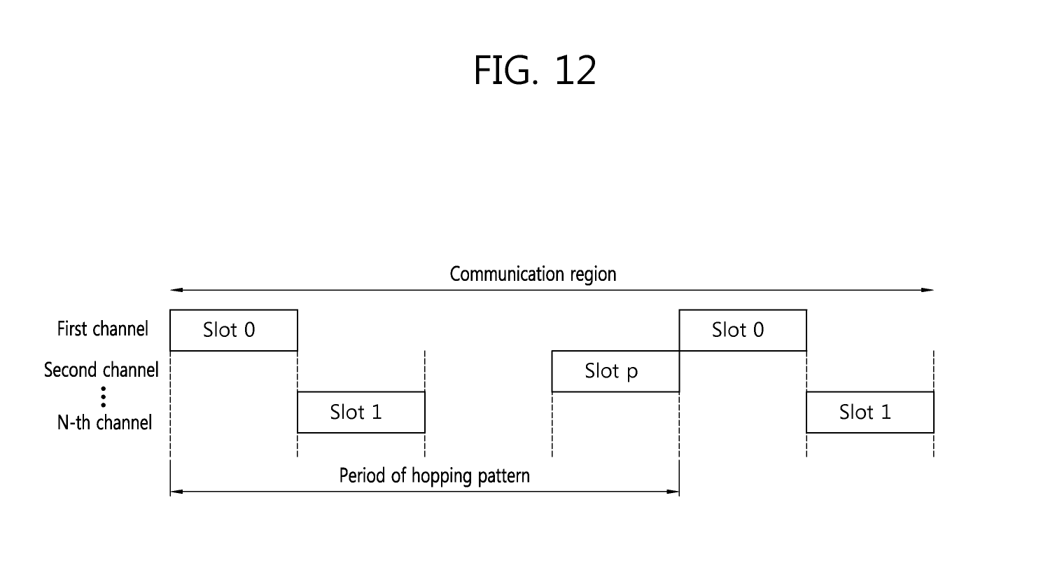

FIG. 11 and FIG. 12 illustrate the peering region and the communication region in detail.

FIG. 11 is a conceptual diagram illustrating a peering region according to an embodiment of the present invention.

In the peering region, the UE may perform synchronization of the slot unit according to the same slot timing as that of the other UE to perform the peering. Upon performing the peering, the UE may exchange hopping pattern information and authentication information.

Referring to FIG. 11, the peering region 1100 may be divided into a first standby region 1120, slot synchronization and peering region 1140, and a second standby region 1160. When slot synchronization is performed, the UE synchronizes a slot of another UE with a slot of the UE. The sizes of the first standby region 1120, the slot synchronization and peering region 1140, and the second standby region 1160 included in the peering region 1100 may be flexible. Hereinafter, the embodiment of the present invention is described on the assumption that the discovering UE transmits a peering request message and the discovery object UE transmits a peering response message.

In the first standby region 1120, the discovering UE may move to a channel region in which the discovery object UE is operated.

In the slot synchronization and peering region 1140, the discovering UE may transmit the peering request message. The peering request message may include device ID information of another UE to be peered. The discovering UE transmitting the peering request message may depend on slot synchronization of the discovery object UE receiving the peering request message.

If the discovery object UE receives the peering request message, the discovery object UE may transmit the peering response message to the discovering UE. The peering response message may include information for peering. The discovering UE may transmit a peering confirmation message to the discovery object UE transmitting the peering response message. In the peering procedure, slot synchronization between the discovering UE and the discovery object UE may be performed based on slot timing information included in the discovery response message received during the discovery procedure.

In the second standby region 1160, the discovering UE may wait to perform communication based on time synchronization which is newly configured by the discovering UE.

As described above, when one UE communicates with a plurality of UEs, the time between the one UE and the plurality of UEs may be synchronized at the peering region 1100. Referring back to FIG. 9, the time among the first UE, the second UE, and the third UE may be synchronized through the peering region 1100. The first UE, the second UE, and the third UE may perform communication at a communication region based on the time synchronization.

In detail, the peering response message may include available channel information, status information, and authentication information. The available channel information may include information on a channel which the UE may use. The status information may include sleep timing and remaining capability information on new connection. The remaining capability information on new connection may include a channel and/or the number of UE which currently performs communication.

The peering confirmation information may include hopping pattern, slot timing, available channel information, status information, and authentication information.

FIG. 12 is a conceptual diagram illustrating a communication region according to an embodiment of the present invention.

Referring to FIG. 12, in the communication region, communication may be performed when peered UEs operate at the same channel.

The peered UE may move the channel according to the hopping pattern (or channel hopping pattern) based on the same slot timing. When each peered UE performs communication while moving a channel according to each hopping pattern, if an operation channel at a specific slot of a plurality of peered UEs is the same, a plurality of peered UEs may communicate with each other.

When the UE does not transmit a separate hopping pattern change signal or does not allocate a discovering region, the same hopping pattern may be repeatedly used. As described above, in the discovery procedure, the UE may monitor a discovery request message transmitted from another UE at the communication region.

The hopping pattern in the communication region of the UE may be used to uniformly allocate a channel to UEs performing D2D communication. Further, when the UE communicates with a plurality of other UEs operating in a plurality of different channels, a channel hopping pattern may be availably used.

The hopping pattern of the UE may be determined based on various methods.

For example, when the UE turns-on power or the UE has one communication link with another UE, the channel hopping pattern of the UE may be determined as the same channel hopping pattern as a channel hopping pattern of a discovery object UE performing the discovery. That is, the discovering UE (discovering device) may determine a second channel hopping pattern based on information on the first channel hopping pattern. The information on the first channel hopping pattern may include information on a first operation channel of a device (discovery object UE) which is hopped and discovered at the communication region during a channel hopping period. The second channel hopping pattern may indicate a second operation channel of the discovering device which is hopped at the communication region during the channel hopping period. According to the embodiment of the present invention, the second channel hopping pattern may be determined so that a first operation channel of a device discovered in at least one slot during the channel hopping period is the same as a second operation channel of a discovering device.

As another example, it may be assumed that the UE communicates with another UE to have a plurality of communication links at the communication region. In this case, the UE may change a part of the channel hopping pattern in order to communicate with a plurality of other UEs discovered by the UE.

For example, it may be assumed that the channel hopping pattern of the UE is ‘2222’ according to the slot. That is, the UE may perform D2D communication by configuring the second channel in a slot #0, a slot #1, a slot #2, and a slot #3 as the operation channel.

It may be assumed that a channel hopping pattern of another UE newly discovered by the UE is ‘3333’ according to the slot. In this case, the UE may communicate with another UE by changing the channel hopping pattern. When the UE changes the channel hopping pattern to be hopped to the third channel instead of the second channel at the slot #0 (that is, when the channel hopping pattern is 3222), the UE may communicate with a newly discovered UE at a slot #0 using the third channel.

In order to transmit information on the hopping pattern of the UE, various parameters may be used. For example, a parameter for transmitting information on a hopping pattern of the UE may include the total number of channels, the number of maximum channels in which the UE may simultaneously communicate with, a length of the hopping pattern, and hopping pattern information.

The hopping pattern information may include channel index information with respect to each slot.

When the channel status is changed, the UE may change a hopping pattern at a communication region. When the hopping pattern of the UE is changed, the UE may transmit information on the changed hopping pattern to a currently communicated other UE.

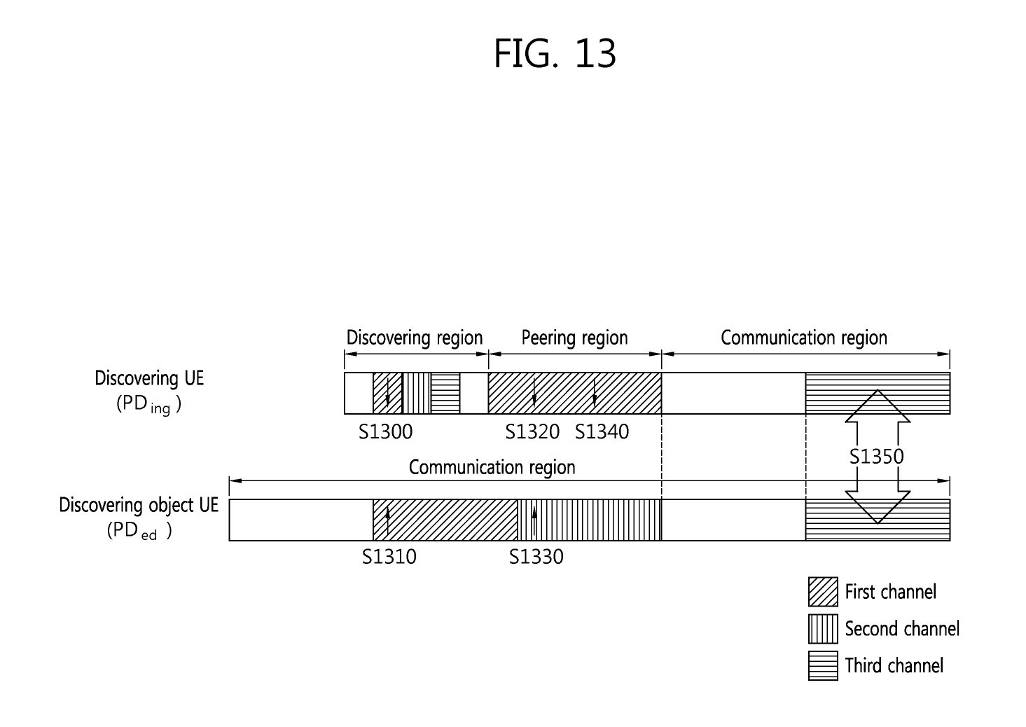

FIG. 13 is a conceptual diagram illustrating a D2D communication method according to an embodiment of the present invention.

FIG. 13 illustrates a method of performing communication between UEs through a discovering region, a peering region, and a communication region.

Referring to FIG. 13, the discovering UE may discover the discovery object UE based on the method illustrated in FIG. 2 to FIG. 8 in the discovering region.

The discovering UE may transmit a discovery request message at the discovering region through the first channel (step S1300).

As described above, the discovery request message may include a device ID of a discovering device and information on a service type.

Another discovery object UE discovered by the discovering UE may transmit a discovery response message to the discovering UE (step S1310).

The discovery response message may include a device ID, a service type, slot timing, and hopping pattern information of the discovery object UE.

If the discovering UE receives a discovery response message from the discovery object UE, the discovering UE may transmit ACK to the discovery object UE.

After the discovery procedure, the discovering UE may move to an operation channel of the discovery object UE based on the hopping pattern information of the discovery object UE to perform a peering procedure.

The discovering UE may move to an operation channel (e.g., second channel) of the discovery object UE according to the hopping pattern information of the discovery object UE to transmit the peering request message (step S1320).

The discovering UE may synchronize the slot according to slot synchronization of the discovery object UE through the peering procedure to perform the peering with the discovery object UE.

If the discovery object UE receives the peering request message, the discovery object UE may transmit a peering response message to the discovering UE (step S1330).

The peering response message may include acceptance and authentication information on peering.

If the discovering UE receives the peering response message, the discovering UE may transmit a peering confirmation message to the discovery object UE (step S1340).

The peering confirmation message may include information on the hopping pattern, authentication information, and the like.

After the above peering procedure, the discovering UE may communicate with the discovery object UE at a communication region (step S1350).

As described above, the discovering UE may communicate with the discovery object UE while hopping the communication channel according to each hopping pattern. When the communication channel hopped in a specific slot is matched, the discovering UE may communicate with the discovery object UE.

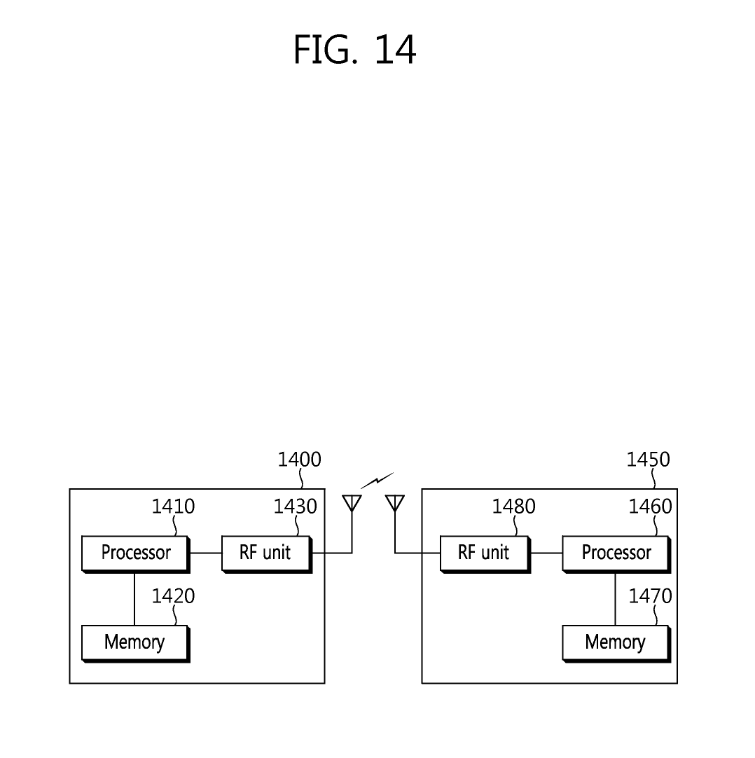

FIG. 14 is a block diagram illustrating a wireless device to which an embodiment of the present invention may apply.

Referring to FIG. 14, the discovering UE(discovering device) may perform operations described in FIG. 1 to FIG. 13.

The discovering UE 1400 includes a processor 1410, a memory 1420, and an RF (Radio Frequency) unit 1430.

The RF unit 1430 may be connected with the processor 1420 to transmit/receive radio signals.

The processor 1420 implements functions, processes, and/or methods as proposed herein. For example, the processor 1420 may be implemented to perform the operation of the above-described wireless device according to an embodiment disclosed in FIG. 2 to FIG. 13 of the present invention.

For example, the processor 1420 transmits a discovery request message through a plurality of channels at a discovering region. The discovering region is a time resource allocated as an integer multiple slots. The processor 1420 receives a discovery response message being a response of the discovery request message from a device (or discovery object UE) discovered through at least one of a plurality of channels in the discovering region. The discovery response message may include slot timing information and information on a first channel hopping pattern. In addition, the processor 1420 may be configured to synchronize with a device discovered based on slot timing information at a peering region and to communicate with a device discovered based on information on the first channel hopping pattern at the communication region. The slot corresponds to one time resource among a plurality of time resources having the same size included in a transmission period of a synchronization signal of the discovering device. The slot timing information includes information on offset of a time when the discovery response message based on a start point of a specific slot. The information on the first channel hopping pattern may include information on a first operation channel of the discovering region hopped during a channel hopping period at the communication region.

Further, the discovery object UE (or discovered device) 1450 may perform an operation of the discovery object device illustrated in FIG. 1 to FIG. 13.

The discovering object UE 1450 includes a processor 1460, a memory 1470, and an RF (Radio Frequency) unit 1480.

The RF unit 1480 may be connected with the processor 1460 to transmit/receive radio signals.

The processor 1460 implements functions, processes, and/or methods as proposed herein. For example, the processor 1460 may be implemented to perform the operation of the above-described wireless device according to an embodiment disclosed in FIG. 2 to FIG. 13 of the present invention.

For example, the processor 1460 may transmit a discovery response signal as a response with respect to the discovery request message received from the discovering device. In addition, the processor 1460 may transmit a peering response signal as a response with respect to a peering request message received from the discovering device. The processor 1460 may communicate with a discovering device at a specific slot of a communication region having the same operation channel as that of the discovering device.

The processor 1410, 1420 may include an ASIC (Application-Specific Integrated Circuit), other chipset, a logic circuit, a data processing device, and/or a converter that performs conversion between a baseband signal and a radio signal. The memory 1420, 1470 may include a ROM (Read-Only Memory), a RAM (Random Access Memory), a flash memory, a memory card, a storage medium, and/or other storage device. The RF unit 1430, 1480 may include one or more antennas that transmit and/or receive radio signals.

When an embodiment is implemented in software, the above-described schemes may be embodied in modules (processes, or functions, etc.) performing the above-described functions. The modules may be stored in the memory 1420, 1470 and may be executed by the processor 1410, 1460. The memory 1420, 1470 may be positioned in or outside the processor 1410, 1460 and may be connected with the processor 1410, 1460 via various well-known means.

What is claimed is:

1. A device-to-device (D2D) communication method comprising:
transmitting, by a discovering device, a discovering request message via each of a plurality of channels in a discovering region, the discovering region corresponding to time resources allocated to integer multiple slot;
receiving, by the discovering device, a discovering response message as a response to the discovering request message from a discovered device through at least one channel among the plurality of channels in the discovering region, the discovering response message containing slot timing information and information on a first channel hopping pattern;
synchronizing with the discovered device based on the slot timing information in a peering region by the discovering device; and
performing communication with the discovered device, by the discovering device based on the information on the first channel hopping pattern in a communication region,
wherein the slot corresponds to one of a plurality of time resources having a same size included in a transmission period of a synchronization signal of the discovering device,
wherein the slot timing information includes information on offset of a time when the discovering response message is transmitted based on a start point of a specific slot, and
wherein the information on the first channel hopping pattern includes information on a first operation channel of the discovered device hopped during a channel hopping period in the communication region.

2. The method of claim 1, wherein the discovering region is divided into a plurality of sub-discovering regions based on a number of the plurality of channels,
wherein each of the plurality of sub-discovering regions correspond to each of the plurality of channels, and
wherein each of the plurality of sub-discovering regions includes a first region for transmitting the discovering request message via corresponding each of the plurality of channels and a second region for monitoring the discovering response message transmitted via each of the plurality of channels.

3. The method of claim 1, wherein the discovering region is divided into a discovering request signal transmission region and a discovering response signal reception region, wherein the discovering request signal transmission region is a region to transmit the discovering request message via each of the plurality of channels, and
wherein the discovering response signal reception region is a region to monitor the discovering response message transmitted via each of the plurality of channels after the discovering request signal transmission region.

4. The method of claim 1, wherein the discovering region is defined in two slots,
wherein the discovering request message is transmitted via each of the plurality of channels in each of the two slots, and
wherein the discovering response message is monitored via each of the plurality of channels in each of the two slots.

5. The method of claim 1, further comprising determining a second channel hopping pattern based on information on the first channel hopping pattern,
wherein the second channel hopping pattern indicates a second operation channel of the discovering device hopped during the channel hopping period in the communication region, and
wherein the second channel hopping pattern is determined so that the first operation channel of the discovered device in at least one slot during the channel hopping period is equal to the second operation channel of the discovering device.

6. A discovering device for performing a device-to-device (D2D) communication, the discovering device comprising:
a radio frequency (RF) unit configured to transmit and receive a radio signal;
a processor operatively connected to the RF unit and configured to:
transmit a discovering request message via each of a plurality of channels in a discovering region, the discovering region corresponding to time resources allocated to integer multiple slot;
receive a discovering response message as a response to the discovering request message from a discovered device through at least one channel among the plurality of channels in the discovering region, the discovering response message containing slot timing information and information on a first channel hopping pattern;
synchronize with the discovered device based on the slot timing information in a peering region by the discovering device; and
perform communication with the discovered device, by the discovering device based on the information on the first channel hopping pattern in a communication region,
wherein the slot corresponds to one of a plurality of time resources having a same size included in a transmission period of a synchronization signal of the discovering device,
wherein the slot timing information includes information on offset of a time when the discovering response message is transmitted based on a start point of a specific slot, and
wherein the information on the first channel hopping pattern includes information on a first operation channel of the discovered device hopped during a channel hopping period in the communication region.

7. The discovering device of claim 6, wherein the discovering region is divided into a plurality of sub-discovering regions based on a number of the plurality of channels,
wherein each of the plurality of sub-discovering regions correspond to each of the plurality of channels, and
wherein each of the plurality of sub-discovering regions includes a first region for transmitting the discovering request message via corresponding each of the plurality of channels and a second region for monitoring the discovering response message transmitted via each of the plurality of channels.

8. The discovering device of claim 6, wherein the discovering region is divided into a discovering request signal transmission region and a discovering response signal reception region, wherein the discovering request signal transmission region is a region to transmit the discovering request message via each of the plurality of channels, and
wherein the discovering response signal reception region is a region to monitor the discovering response message transmitted via each of the plurality of channels after the discovering request signal transmission region.

9. The discovering device of claim 6, wherein the discovering region is defined in two slots,
wherein the discovering request message is transmitted via each of the plurality of channels in each of the two slots, and
wherein the discovering response message is monitored via each of the plurality of channels in each of the two slots.

10. The discovering device of claim 6,
wherein the processor further configured to determine a second channel hopping pattern based on information on the first channel hopping pattern,
wherein the second channel hopping pattern indicates a second operation channel of the discovering device hopped during the channel hopping period in the communication region, and
wherein the second channel hopping pattern is determined so that the first operation channel of the discovered device in at least one slot during the channel hopping period is equal to the second operation channel of the discovering device.
